(19) United States
(12) Patent Application Publication
(10) Pub. No.: US 2025/0050813 A1
(43) Pub. Date: Feb. 13, 2025

(54) STORAGE COMPARTMENTS FOR VEHICLES WITH SEGMENTS INCLUDING RECESSED PORTIONS FORMING STORAGE CAVITIES

(71) Applicant: Volvo Car Corporation, Göteborg (SE)

(72) Inventors: Edvin Mellergård, Göteborg (SE); Meltem Temur, Göteborg (SE); Eric Löfstedt, Göteborg (SE); Rohit Bailey, Göteborg (SE)

(21) Appl. No.: 18/232,404

(22) Filed: Aug. 10, 2023

(51) Int. Cl. B60R 7/04; B65D 8/00

(52) U.S. Cl. CPC B60R 7/04; B65D 15/24

(57) ABSTRACT

Bifurcated and split-configuration storage compartments for a vehicle including a first container segment and a second container segment each configured to be secured to the vehicle. The first container segment includes a first body defining a first recessed interior and a first continuous flange or first flange(s) extending from an exterior of the first body and at least partially defining a perimeter of the first recessed interior. The second container segment includes a second body defining a second recessed interior and a second continuous flange or second flange(s) extending from an exterior of the second body and at least partially defining a perimeter of the second recessed interior. The first and second flanges define complementary profiles such that the first and second flanges may be coupled together to form a cavity for storing items or cargo from the first recessed interior and the second recessed interior.

### TECHNICAL FIELD

The present disclosure is generally directed to the automotive field. More particularly, the present disclosure relates to storage compartments that may be installed in or on vehicles.

### BACKGROUND

There currently exist many types, styles, and models of vehicles. These different vehicles are typically designed with various types of engines and motors positioned at different locations within the vehicles. Also, the passenger space of different vehicles may vary widely, the designed spaces of which may range from two-passenger vehicles to multi-passenger vans. After designing the operational equipment and the passenger spaces of a vehicle, a designer may then attempt to take advantage of extra spaces that can be used as storage spaces for hauling cargo and various items. For some vehicles, such as pick-up trucks, a designated cargo space (e.g., the bed of the pick-up truck) may be a more significant part of the design process.

In some vehicles, such as electric vehicles and vehicles with a rear-mounted engine, extra space may be available for storage at the front end of the vehicle. As such, under the front hood of such a vehicle, a person would not find a conventional engine compartment, but perhaps a storage space or trunk. This trunk located in the front of a vehicle is sometimes referred to as a “frunk.” Existing storage compartments and frunks include a monolithic body defining the storage cavity of the storage compartment or frunk. Such monolithic storage compartments and frunks are typically produced utilizing an injection molding process of a plastic material.

However, such monolithic structures are associated with several problems or disadvantages. For example, the entire monolithic structure is typically formed from the same plastic material or mix of plastic materials. Such monolithic storage compartment bodies may be overdesigned, include excessive plastic material, or may be relatively thick in order to accommodate the largest operational loads expected for high stress portions of the monolithic bodies of the storage compartments or frunks. Some such monolithic body structures include integral portions thereof with increased thickness and designed to accommodate such high operational loads. Typically, a plastic material suitable for the highest operational loads experienced by the monolithic body of the storage compartment may not be as sustainable as a plastic material capable of withstanding the operational loads that act on the remaining portions of the monolithic storage compartment body. Some plastic materials utilized to form such monolithic storage compartment bodies may not be recyclable or may require a relatively expensive or involved recycling process. Furthermore, draft angles for the cavities defined by such monolithic storage compartment bodies limit and internal storage volume of the resulting storage cavity because such draft angles must be sufficiently large enough to allow for removing the produced parts from the associated molding tools.

As such, a need exists in the art for an improved storage compartment for vehicles that overcomes the above limitations.

This background is provided as an illustrative contextual environment only. It will be readily apparent to those of ordinary skill in the art that the systems and methods of the present disclosure may be implemented in other contextual environments as well.

### SUMMARY

Therefore, it is an object of the invention to provide storage compartments for vehicles that overcome the limitations of the known art. Disclosed are bifurcated storage compartments, each including two separate container segments defining separate recessed interiors. The separate container segments include flanges, e.g., continuous flanges, arranged around or defining the recessed interiors of the respective container segments. The flanges of the container segments may generally define complementary or matching profiles in order to couple the segments together and form a single storage cavity from the recessed interiors of the initial, separate segments. Thus, embodiments of the bifurcated storage compartment disclosed herein allow for the segments thereof to be formed thinner, lighter, or from more sustainable and/or different materials able to withstand the structural requirements particular to each segment, as compared to monolithic body storage compartments. The disclosed segments are each generally stackable such that stacks of first segments and stacks of second segments may be shipped, transported, or the like to a final assembly location where pairs of first and second segments may be assembled and installed in the associated vehicle. By forming separate segments of the bifurcated storage compartment, the draft angles of the assembled cavity are substantially reduced in comparison to a storage cavity defined by a monolithic storage compartment body.

In various instances, one of the segments may be formed from one or more plastic materials, such as one or more bioplastics, that is more sustainable, e.g., may be recycled or recycled utilizing a relatively inexpensive or more efficient recycling process. In some configurations, one segment may be formed from the plastic material(s) that are less sustainable but suitable to withstand the largest loads experienced by the assembled storage container. The other segment may be formed from different plastic materials that are more sustainable and also capable of withstanding smaller loads experienced by the other segment of the bifurcated storage compartment. In some embodiments, the bifurcated storage compartment may include one or more load carriers suitable to structurally support the bifurcated storage compartment and, in some embodiments, secure the flanges of the separate container segments together. In general, each component or part of the assembled bifurcated storage compartment may be disassembled from the rest of the assembly and disposed of or recycled utilizing the most sustainable procedure that the component allows for.

Some embodiments of the disclosed storage compartments may be configured as a split-configuration storage compartment including two separate container segments coupled together with a living hinge. The container segments include flanges such that, when the split-configuration storage compartment is folded at the living hinge to bring the container segments together, the respective flanges may be coupled and secured together. Embodiments of the split-configuration storage compartment may also be formed from more sustainable materials, may be formed thinner and lighter, and/or may allow for reduced draft angles and larger resulting storage cavities, as compared to monolithic storage compartment bodies. The split-configuration storage compartment may be utilized in conjunction with one or more load carriers, allowing for the disassembly and separate recycling and/or disposal of the container segments and the load carrier(s). Furthermore, split-configuration storage compartments may be stacked in their open configurations to improve transportation logistics.

To achieve the foregoing and other objects and advantages, in one aspect, the present subject matter is directed to a bifurcated storage compartment for a vehicle including a first container segment and a second container segment each configured to be secured to the vehicle. The first container segment includes a first body defining a first recessed interior. The second container segment includes a second body defining a second recessed interior. The first container segment and the second container segment define complementary profiles such that the first container segment and the second container segment may be coupled together to form a cavity from the first recessed interior and the second recessed interior. The formed cavity is configured to store items or cargo.

In at least one embodiment, the first body may include at least one first flange extending from an exterior of the first body such that the at least one first flange at least partially defines a perimeter of the first recessed interior. The second body may include at least one second flange extending from an exterior of the second body such that the at least one second flange at least partially defines a perimeter of the second recessed interior. The at least one first flange and the at least one second flange may define complementary profiles such that the at least one first flange and the at least one second flange may be coupled together to form the cavity from the first recessed interior and the second recessed interior. In additional or alternative embodiments, the at least one first flange may be configured as a first continuous flange extending from the exterior of the first body and defining the perimeter of the first recessed interior. In some embodiments, the first body of the first container segment may include opposing first sidewalls, a first bottom wall extending between the opposing first sidewalls, and a front wall extending from the first bottom wall and between the opposing first sidewalls. In some such embodiments, the first continuous flange may extend from an exterior of each of the opposing first sidewalls and the first bottom wall. In an additional or alternative embodiment, the at least one second flange may be configured as a second continuous flange extending from the exterior of the second body and defining the perimeter of the second recessed interior. Additionally or alternatively, the second body of the second container segment may include opposing second sidewalls, a second bottom wall extending between the opposing second sidewalls, and a back wall extending from the second bottom wall and between the opposing second sidewalls. In some such embodiments, the second continuous flange may extend from an exterior of each of the opposing second sidewalls and the second bottom wall. Additionally or alternatively, each of the opposing second sidewalls and the back wall may include a vertically extending leg and a horizontally extending leg such that the second recessed interior includes a bottom recess and an orthogonal top recess. In additional or alternative embodiments, the first body may be a monolithic structure comprising a first material, and the second body may be a monolithic structure comprising a second material different than the first material.

In further or alternative embodiments, the bifurcated storage compartment may further include a top load carrier configured to couple to the second body proximate to a top edge of the back wall such that the top load carrier extends between the opposing second sidewalls when coupled to the second body and secures the second body to the vehicle. In some such embodiments, the top load carrier may include an elongate body with a first snap hook proximate to a first end of the elongate body and a second snap hook proximate to a second end of the elongate body. The first snap hook may be configured to be coupled to the back wall proximate to the top edge of the back wall and one sidewall of the opposing second sidewalls. The second snap hook may be configured to be coupled to the back wall proximate to the top edge of the back wall and other sidewall of the opposing second sidewalls. In additional or alternative embodiments, the second body of the second container segment may include a top flange extending from a top edge of the back wall and defining a plurality of retention cavities or holes. The top load carrier may include a plurality of protrusions positioned between the first and second ends of the elongate body such that, when the top load carrier is coupled to the back wall of the second body, the plurality of protrusions of the top load carrier are received within the retention cavities or holes defined by the top flange to secure the top load carrier to the back wall.

In additional or alternative embodiments, the bifurcated storage compartment may further include a bottom load carrier configured to enclose the at least one first flange and the at least one second flange when the at least one first flange and the at least one second flange are coupled together such that the at least one first flange and the at least one second flange are secured together. In additional or alternative embodiments, the bifurcated storage compartment may further include at least one sealing strip configured to be positioned between the at least one first flange and the at least one second flange such that, when the at least one first flange and the at least one second flange are coupled together and secured, a seal is created therebetween.

In some further or alternative embodiments, at least one of a plurality of screws or a plurality of clips of the at least one first flange may be configured to retain the at least one second flange when the at least one first flange and the at least one second flange are coupled together. In additional or alternative embodiments, the at least one second flange may include a second rib protruding from the at least one second flange such that a channel is defined between the second rib of the at least one second flange and the exterior of the second body. The channel may be configured to house a sealing element. In an additional or alternative embodiment, the at least one first flange may include a first rib protruding from the at least one first flange. The first rib may be configured to compress the sealing element housed within the channel of the second body to create a seal therebetween when the at least one first flange and the at least one second flange are coupled together and secured. In further or alternative embodiments, the at least one first flange may include a plurality of steering ribs protruding from the at least one first flange and/or or the first rib and spaced along the at least one first flange with some distance in between. The plurality of steering ribs may be configured to be received within the channel defined by the second rib in order steer the at least one first flange and the at least one second flange together and ensure an even interface therebetween when the at least one first flange and the at least one second flange are coupled together and secured. In additional or alternative embodiments, the at least one first flange may include at least one steering pin, and the at least one second flange may define at least one guide hole or guide cavity configured to receive the at least one steering pin in order to ensure a proper alignment when the at least one first flange and the at least one second flange are coupled together.

In an additional or alternative aspect, the present subject matter is directed to a split-configuration storage compartment for a vehicle including a first container segment with a first body defining a first recessed interior and configured to be secured to the vehicle. The split-configuration storage compartment further includes a second container segment including a second body defining a second recessed interior and configured to be secured to the vehicle. The split-configuration storage compartment also includes a living hinge positioned between and coupling the first body to the second body such that the first container segment and the second container segment each extend from the living hinge to form the split-configuration storage compartment.

In some embodiments, the first container segment may further include a plurality of first flanges, and each first flange may extend from an exterior of the first body such that the plurality of first flanges at least partially defines a perimeter of the first recessed interior. In additional or alternative embodiments, the second container segment may further include a plurality of second flanges, and each second flange may extend from an exterior of the second body such that the plurality of second flanges at least partially defines a perimeter of the second recessed interior. In some such embodiments, the plurality of first flanges and the plurality of second flanges may define complementary profiles such that the plurality of first flanges and the plurality of second flanges may be coupled together to form a cavity from the first recessed interior and the second recessed interior. The formed cavity may be configured to store items or cargo.

In additional or alternative embodiments, the split-configuration storage compartment may further include a bottom load carrier configured to enclose the plurality of first flanges and the plurality of second flanges when the plurality of first flanges and the plurality of second flanges are coupled together such that the plurality of first flanges and the plurality of second flanges are secured together. In a further or alternative embodiment, the split-configuration storage compartment may also include a plurality of sealing strips, and each sealing strip may be configured to be positioned between one first flange of the plurality of first flanges and one second flange of the plurality of second flanges. Thus, when the plurality of first flanges and the plurality of second flanges are coupled together and secured, the plurality of sealing strips in combination with the living hinge may create a seal between the first container segment and the second container segment.

Embodiments of the invention can include one or more or any combination of the above features and configurations.

Additional features, aspects, and advantages of the invention will be set forth in the detailed description of illustrative embodiments that follows, and in part will be readily apparent to those skilled in the art from that description or recognized by practicing the invention as described herein. It is to be understood that both the foregoing general description and the following detailed description present various embodiments of the invention and are intended to provide an overview or framework for understanding the nature and character of the invention as it is claimed. The accompanying drawings are included to provide a further understanding of the invention and are incorporated in and constitute a part of this specification.

### BRIEF DESCRIPTION OF THE DRAWINGS

A full and enabling disclosure of the present invention, including the best mode thereof, directed to one of ordinary skill in the art, is set forth in the specification, which makes reference to the companying drawings, in which:

FIG. 1 illustrates a schematic side view of one embodiment of a vehicle including storage spaces, in accordance with aspects of the present subject matter;

FIG. 2 illustrates a top perspective view of one embodiment of a bifurcated storage compartment, in accordance with aspects of the present subject matter;

FIG. 3 illustrates a cross-section of one embodiment of a bifurcated storage compartment in comparison to a cross-section of monolithic body storage compartment, in accordance with aspects of the present subject matter;

FIG. 4 illustrates a cross-section of one embodiment of a bottom portion of a bifurcated storage compartment showing a channel thereof, in accordance with aspects of the present subject matter;

FIG. 5 illustrates a cross-section of another embodiment of a bifurcated storage compartment showing steering ribs thereof, in accordance with aspects of the present subject matter;

FIG. 6 illustrates a bottom perspective view of one embodiment of a bifurcated storage compartment, in accordance with aspects of the present subject matter;

FIG. 7 illustrates a top perspective view of one embodiment a bifurcated storage compartment including a bottom load carrier, in accordance with aspects of the present subject matter;

FIG. 8 illustrates a bottom perspective view of one embodiment of a bifurcated storage compartment including a bottom load carrier and a top load carrier, in accordance with aspects of the present subject matter;

FIG. 9A illustrates a cross-section of one embodiment of a bifurcated storage compartment including a bottom load carrier with a sealing element, in accordance with aspects of the present subject matter;

FIG. 9B illustrates a cross-section of one embodiment of a bifurcated storage compartment with overlaid edges and a bottom load carrier, in accordance with aspects of the present subject matter;

FIG. 9C illustrates a cross-section of one embodiment of a bifurcated storage compartment with abutting edges and a bottom load carrier, in accordance with aspects of the present subject matter;

FIG. 9D illustrates a cross-section of one embodiment of a bifurcated storage compartment with hinges coupling the bottom edges of the container segments together and a bottom load carrier, in accordance with aspects of the present subject matter;

FIG. 10 illustrates a top, back perspective view of one embodiment of a bifurcated storage compartment including a bottom load carrier and a top load carrier, in accordance with aspects of the present subject matter;

FIG. 11 illustrates a front view of one embodiment of a bifurcated storage compartment showing a top flange of a first container segment, in accordance with aspects of the present subject matter;

FIG. 12 illustrates a top perspective view of one embodiment of a bifurcated storage compartment showing a top flange coupled to a top load carrier, in accordance with aspects of the present subject matter;

FIG. 13 illustrates a bottom perspective view of one embodiment of a split-configuration storage compartment including a living hinge and in a closed configuration, in accordance with aspects of the present subject matter;

FIG. 14 illustrates a top perspective view of one embodiment of a split-configuration storage compartment including a living hinge and in an open configuration, in accordance with aspects of the present subject matter;

FIG. 15 illustrates a top perspective view of one embodiment of a split-configuration storage compartment including a living hinge in both an open configuration and a closed configuration, in accordance with aspects of the present subject matter;

FIG. 16 illustrates cross-section of one embodiment of a split-configuration storage compartment including a bottom load carrier, in accordance with aspects of the present subject matter; and

FIG. 17 illustrates a cross-section of one embodiment of a split-configuration storage compartment including a bottom load carrier with a sealing element, in accordance with aspects of the present subject matter.

Repeat use of reference characters in the present specification and drawings is intended to represent the same or analogous features or elements of the present invention.

### DESCRIPTION OF ILLUSTRATIVE EMBODIMENTS

The present invention will now be described more fully hereinafter with reference to the accompanying drawings in which exemplary embodiments of the invention are shown. However, the invention may be embodied in many different forms and should not be construed as limited to the representative embodiments set forth herein. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. It is envisioned that other embodiments may perform similar functions and/or achieve similar results. Any and all such equivalent embodiments and examples are within the scope of the present invention and are intended to be covered by the appended claims.

The exemplary embodiments are provided so that this disclosure will be both thorough and complete and will fully convey the scope of the invention and enable one of ordinary skill in the art to make, use, and practice the invention. The word “exemplary” is used herein to mean “serving as an example, instance, or illustration.” Any implementation described herein as “exemplary” is not necessarily to be construed as preferred or advantageous over other implementations.

The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “first”, “second”, and “third” may be used interchangeably to distinguish one component from another and are not intended to signify location or importance of the individual components. The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

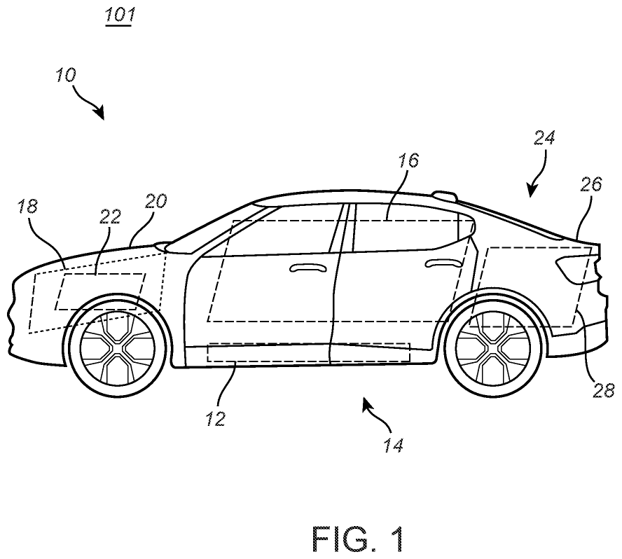

Referring now specifically to FIG. 1, a side view of a vehicle 10 having one or more storage compartments is illustrated in accordance with aspects of the present disclosure. In particular, the vehicle 10 includes at least one storage compartment, as described in the present disclosure, which is configured as a bifurcated storage compartment or a split-configuration storage compartment.

In some embodiments, the vehicle 10 may be an electric vehicle having electrical components (e.g., batteries) 12 for propelling the vehicle 10. Many of the electrical components 12 for driving the vehicle 10 may be positioned in a bottom portion 14 of the vehicle 10 below a passenger cabin 16. As such, the electric vehicle 10 of course does not include an internal combustion engine in a front space 18 under a front hood 20 of the vehicle 10. Thus, the extra front space 18 may accommodate a frunk 22 under the front hood 20. As defined herein, a “frunk” is a storage compartment or “trunk” that may be positioned near the front of the vehicle 10 under the front hood 20. Some frunks 22 may be designed so as not to obstruct access to certain parts of the vehicle 10 that may reside under the front hood 20.

Many of the electrical components 12 for driving an electric vehicle may be smaller than a conventional combustion engine; thus, when the vehicle 10 is configured as an electric vehicle, the front space 18 under the front hood 20 that may normally include the engine and other components may in this case have a cavity.

Alternatively, the vehicle 10 may be configured with a rear-mounted engine within a back space under a trunk door 26 of the vehicle 10. In this embodiment, the trunk door 26 may not be configured to conceal a typical trunk, but instead may be configured to conceal the rear-mounted engine. Again, with such a design, the front space 18 may be available to accommodate the frunk 22.

In other embodiments, the vehicle 10 may be configured as a hybrid vehicle, which is driven by both gasoline and electrical power. A small internal combustion engine may be mounted under the front hood 20 or in the back space 24 under the trunk door 26, while the battery components of the hybrid engine may be mounted in the bottom portion 14 of the vehicle 10 under the passenger cabin 16 or mounted in the back space 24 under the trunk door 26. When configured as a hybrid vehicle, the vehicle 10 may include storage compartments (e.g., frunk 22, trunk 28) that may be accessible by lifting the front hood 20 or trunk door 26.

Regardless of the type of power train, design, or model of the vehicle 10, the vehicle 10 may include storage compartments located at various locations, such as in the front space 18, the back space 24, or even within the passenger cabin 16 of the vehicle 10. In some embodiments, the vehicle 10 may include a bed (e.g., on a pick-up truck), a roof-rack, a trunk-rack, bumper, or other storage areas that are located on an exterior of the vehicle 10 and/or at other spaces within the vehicle 10. Some of the spaces (e.g., the back space 24 and the passenger cabin 16) may be somewhat isolated from the environment, while other spaces (e.g., the front space 18 and/or exterior spaces) may be exposed to the environment to some extent.

It will be appreciated, however, that the exemplary vehicle 10 depicted in FIG. 1 is by way of example only, and that in other exemplary embodiments, the vehicle 10 may have any other suitable configuration, including, for example, any other suitable number of rows of seats, rows of doors, etc. Additionally or alternatively, in other exemplary embodiments, any other suitable power sources may be provided. For example, in other exemplary embodiments, the vehicle 10 may include an internal combustion engine, a liquid hydrogen powered engine, etc.

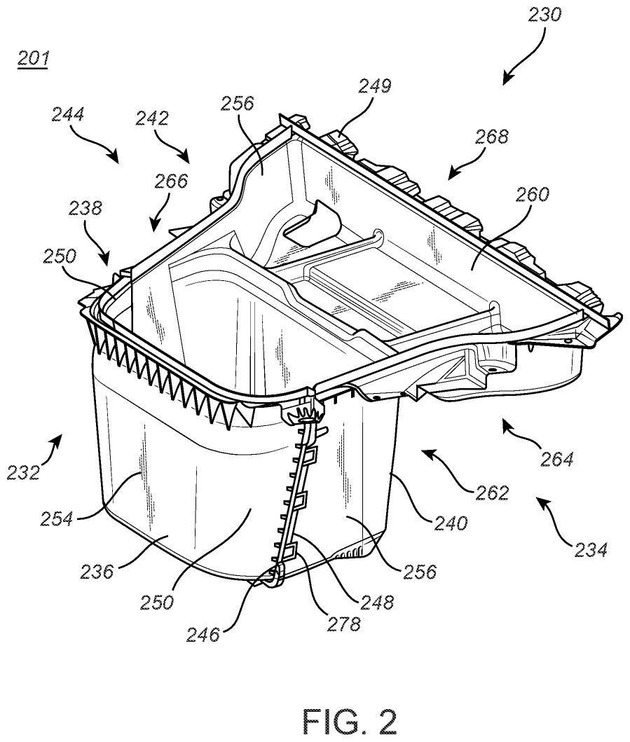

Referring now to FIGS. 2-6, schematic views of exemplary embodiments of a bifurcated storage compartment are illustrated in accordance with aspects of the present subject matter. A bifurcated storage compartment 230 may be incorporated into an electric vehicle or hybrid vehicle as described above in reference to FIG. 1, or alternatively may be integrated into any other suitable vehicle. In various embodiments, the bifurcated storage compartment 230 may be configured as a frunk 22. However, additional or alternative embodiments of the bifurcated storage compartment 230 may be configured for the back space 24 under the trunk door 26 (e.g., a trunk) or another suitable free space of the vehicle 10 configured for cargo storage.

Referring now particularly to FIG. 2, a top perspective view of a bifurcated storage compartment is illustrated in accordance with aspects of the present subject matter. The bifurcated storage compartment 230 for a vehicle may include a first container segment 232 and a second container segment 234. Each of the container segments 230, 232 is generally configured to be secured to a suitable vehicle, e.g., the vehicle 10 of FIG. 1. The first container segment 232 includes a first body 236 defining a first recessed interior 238. Likewise, the second container segment 234 includes a second body 240 defining a second recessed interior 242. The first container segment 232 and the second container segment 234 may be coupled together to form a cavity 244 from the first recessed interior 238 and the second recessed interior 242. The formed cavity 244 is configured to store items or cargo.

The first container segment 232 may include a first continuous flange 246 extending from an exterior of the first body 236 such that the first continuous flange 246 at least partially defines a perimeter of the first recessed interior 238. The second container segment 234 may include a second continuous flange 248 extending from an exterior of the second body 240 such that the second continuous flange 248 at least partially defines a perimeter of the second recessed interior 242. The first continuous flange 246 and/or the second continuous flange 248 may extend approximately perpendicular to the exterior of the first body 236 and/or the exterior of the second body 240, respectively. The first continuous flange 246 and the second continuous flange 248 may generally define complementary profiles such that the first continuous flange 246 and the second continuous flange 248 may be coupled together to form the cavity 244 from the first recessed interior 238 and the second recessed interior 242. While described here as continuous flanges 246, 248, it should be appreciated that the first body 236 may include a plurality of first flanges extending from first body 236, and the second body 240 may also include a plurality of second flanges extending from the second body 240. The plurality of first flanges and second flanges may similarly define complementary profiles such that the first flanges and the second flange may be coupled together to form the cavity 244 from the first recessed interior 238 and the second recessed interior 242. In additional or alternative embodiments, first body 236 and/or the second body 240 may not include flanges, and the edges of the first body 236 and second body 240 defining the respective recessed interior 238, 242 may abut against one another when the first container segment 232 and the second container segment 234 are assembled together to form the bifurcated storage compartment 230. In additional or alternative embodiments, one of the first body 236 or the second body 240 may define a slot, recession, or the like on the edge defining the cavity thereof and configured to receive the other edge of the other of the first body 236 or the second body 240 when the first container segment 232 and the second container segment 234 are assembled together to form the bifurcated storage compartment 230.

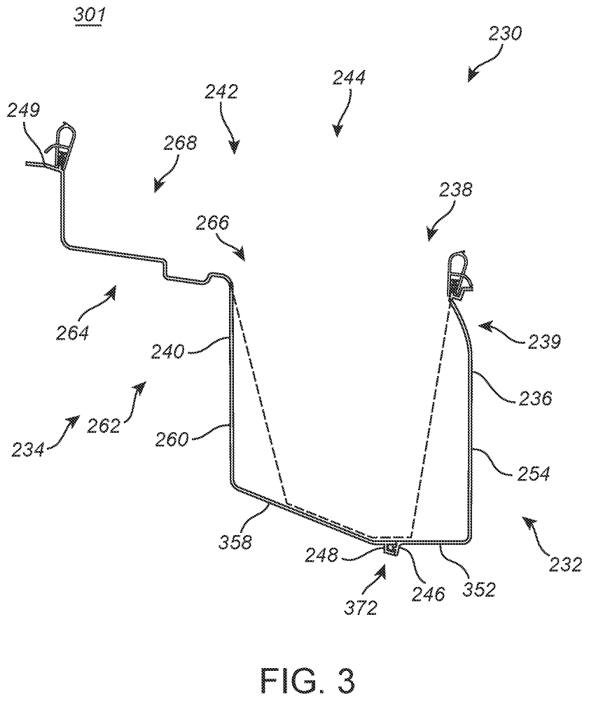

In at least one embodiment, the first body 236 of the first container segment 232 may include opposing first sidewalls 250, a first bottom wall 352 (see, e.g., FIG. 3) extending between the opposing first sidewalls 250, and a front wall 254 extending from the first bottom wall 352 and between the opposing first sidewalls 250. Thus, the opposing first sidewalls 250, the first bottom wall 352, and/or the front wall 254 may define the first recessed interior 238 of the first container segment 232. In some embodiments, the first continuous flange 246 may extend from an exterior of each of the opposing first sidewalls 250 and the first bottom wall 352.

In an additional or alternative embodiment, the second body 240 of the second container segment 234 may include opposing second sidewalls 256, a second bottom wall 358 (see, e.g., FIG. 3) extending between the opposing second sidewalls 256, and a back wall 260 extending from the second bottom wall 358 and between the opposing second sidewalls 256. Thus, the opposing second sidewalls 256, the second bottom wall 358, and/or the back wall 260 may define the second recessed interior 242 of the second container segment 234. In some such embodiments, the second continuous flange 248 may extend from an exterior of each of the opposing second sidewalls 256 and the second bottom wall 358. Additionally or alternatively, each of the opposing second sidewalls 256 and the back wall 260 may include a vertically extending leg 262 and a horizontally extending leg 264 such that the second recessed interior 242 includes a bottom recess 266 and an approximately orthogonal top recess 268.

It should be appreciated that the shapes of first body 236, the first recessed interior 238, the second body 240, and/or the second recessed interior 242 may generally be configured for or suitable for a particular storage space of a vehicle (e.g., front space 18 of vehicle 10). For instance, first container segment 232, the first body 236, the second container segment 234, the second body 240, and/or the bifurcated storage compartment 230 may each define a height, width, depth, and aspect ratio suitable for the associated storage space of the vehicle 10. In some embodiments, the second body 240 may not include leg portions 262, 264 defining the bottom recess 266 and top recess 268 but may be configured similar to the first body 236. In other embodiments, the first body 236 may define leg portions similar to the second body 240 such that the first recessed interior 238 defines recess portions similar to those defined by the second body 240 (e.g., a first bottom recess and first top recess).

In various embodiments, the first body 236 may be a monolithic structure including or formed from a first material, and the second body 240 may be a monolithic structure including or formed from a second material. For instance, the second material may be different than the first material. In alternative embodiments, the first body 236 and the second body 240 may be formed from the same material. In some embodiments, the first body 236 and/or the second body 240 may include a PET material. For example, the first body 236 and/or the second body 240 may be formed from one or more hot pressed plastic materials, such as hot-pressed PET. In additional or alternative embodiments, the first body 236 and/or the second body 240 may formed utilizing injection molding of the first material and/or the second material, respectively. Furthermore, the first body 236 and/or the second body 240 may generally be formed from one or more lightweight materials as in comparison to a single monolithic structure that defines a storage cavity.

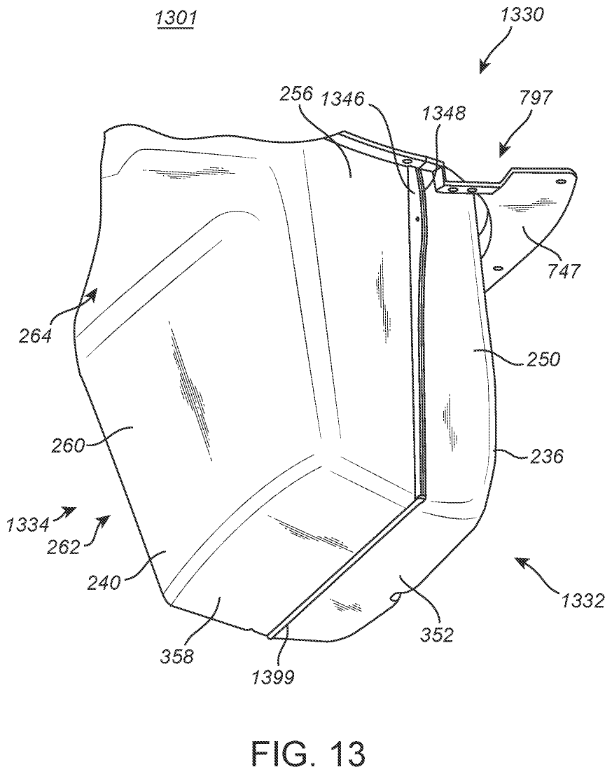

The process of manufacturing a storage compartment from separate component halves allows for the use of thinner and/or lighter weight materials. Thus, the assembled bifurcated storage compartment 230 may be lighter weight in comparison to a storage compartment with a monolithic body defining the storage cavity. Furthermore, the bifurcated storage compartment 230 and/or a split-configuration storage compartment as described herein (see, e.g., FIGS. 13-17) may also provide additional storage volume and/or an improved weight to volume ratio as compared to a storage compartment with a monolithic body defining the storage cavity. This reduction in weight of the bifurcated storage compartment 230 generally improves the efficiency of the car battery and/or the vehicle 10. A lighter weight storage compartment (e.g., various embodiments of the bifurcated storage compartment 230 disclosed herein) may also reduce the expected operational loads and allow for the design of the support mechanism for the bifurcated storage compartment 230 to be simplified.

Furthermore, embodiments of the bifurcated storage compartment 230 disclosed herein allow for the first container segment 232 and the second container segment 234 to transported separately and in bulk to final locations where the segments 232, 234 are assembled and/or installed in the same or different vehicles (e.g., the same or different configurations of the vehicle 10). For example, the first container segments 232 and the second container segments 234 may be separately stacked and shipped. It should be appreciated that stacked segments 232, 234 may be packed more efficiently than a monolithic storage compartment and result in improved transportation logistics and cost savings while reducing the environmental impact of such transportation.

Furthermore, the first body 236 and/or the second body 240 may be formed from a recyclable material(s) to promote sustainability. In some embodiments, the first body 236 and/or the second body 240 may include one or more bioplastics. In some embodiments, the second container segment 234 may generally be configured to withstand greater operational loads while still being capable of recycling. In further or alternative embodiments, the first container segment 232 may generally be configured to withstand smaller operational loads but have greater sustainability (e.g., contains a smaller percentage of traditional oil-based plastics or may be recycled with processes that are cheaper than those suitable for the second container segment 232 and/or traditional plastic materials).

In some embodiments, the assembled bifurcated storage compartment 230 may include or be utilized with one or more load carriers, described in more detail below, such that the design of the support mechanism for expected operational loads on the bifurcated storage compartment 230 may be simplified. In various embodiments, the disclosed load carriers may be formed from traditional plastic materials or include a higher percentage of traditional plastic materials to accommodate the higher operational loads expected for such support elements. It should be appreciated that various embodiments of the bifurcated storage compartment 230 include only some components that may be recycled or include components that generally require different recycling processes. Thus, disclosed embodiments of the bifurcated storage compartment 230 are configured for disassembly of the constituent components in order to allow for sorting and separate recycling of such components (e.g., the first container segment 232, the second container segment 234, and/or the associated load carrier component(s)).

Referring particularly to FIG. 3, a cross-section of one exemplary embodiment of a bifurcated storage compartment is illustrated in comparison to a cross-section of monolithic body storage compartment and/or frunk, in accordance with aspects of the present subject matter. As shown, by separately forming the first body 236 of the first container segment 232 and the second body 240 of the second container segment 234, the resulting cavity 244 of the bifurcated storage compartment 230 generally defines reduced draft angles resulting in a larger cavity volume, advantageously increasing cargo storage space. Storage compartments where the storage cavity is formed by a monolithic component are typically produced utilizing an injection molding process or a compression molding process. Inherent to the injection molding process and/or the compression molding process is designing the part with draft angles on the sides in order to remove the part from the molding tool. These draft angles generally limit the maximum volume of the formed part and reduce the bottom area significantly for parts that are deep or tall.

Thus, FIG. 3 illustrates in phantom a cross-section of a storage cavity of a representative storage compartment defined by a monolithic body formed utilizing injection molding. As shown, the draft angles of the monolithic storage compartment are much greater, result in reduced overall volume, and significantly reduces the area at the bottom of the cavity in comparison to the cavity 244 of the bifurcated storage compartment 230. As shown in FIG. 3 and in some embodiments, the first body 236 may also define an undercut area 239 of the first recessed interior 238. For example, the opposing first sidewalls 250 and a front wall 254 of the first body 236 may define the undercut area 239 in order to enlarge the volume of the cavity 244 formed when the first container segment 232 and the second container segment 234 are assembled into the bifurcated storage compartment 230.

It should be appreciated that the monolithic storage compartment has less storage space overall and particularly toward the bottom portion of the cavity. Cargo that is small enough to enter the top of the monolithic storage compartment may not be small enough to be slid to the bottom of the monolithic storage compartment. In other words, the storage cavity of a monolithic storage compartment generally tapers from a larger cross-section at the top to a smaller cross-section at the bottom. A tapering storage compartment cavity may be particularly problematic for square/rectangular cargo and rigid cargo. Some injection molded storage compartments attempt to reduce the draft angles thereof and to increase the storage capacity utilizing a slider tool during production to assist with removal of the formed storage compartment from the mold. However, even the use of such a slider tool does not reduce the draft angles or increase the internal volume of the storage cavity to the degree of embodiments of the bifurcated storage compartment 230 disclosed herein. Furthermore, the use of such a slider tool prevents manufactured parts from being stacked for transport, unlike the first container segments 232 and the second container segments 234 of the bifurcated storage compartments 230.

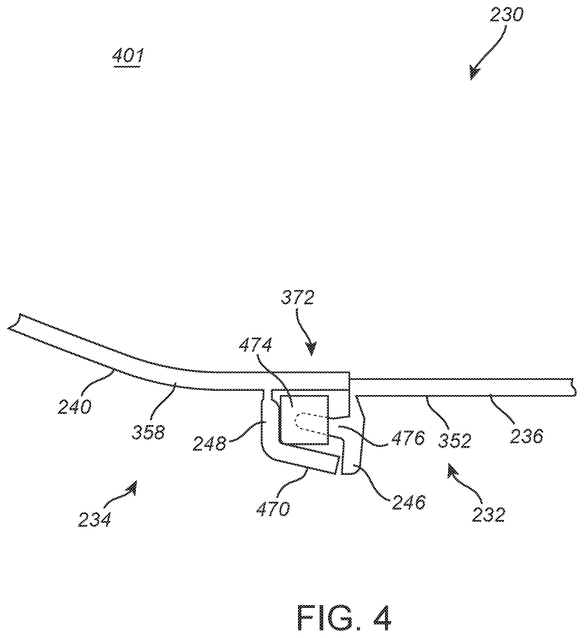

Referring now particularly to FIG. 4, a cross-section of a bottom portion of one exemplary embodiment of a bifurcated storage compartment is illustrated showing a channel thereof, in accordance with aspects of the present subject matter. As shown, the first continuous flange 246 may include a first rib 476 protruding from the first continuous flange 246. Furthermore and in some embodiments, the second continuous flange 248 may include a second rib 470 protruding from the second continuous flange 248. Referring now also to FIG. 3, a channel 372 may be defined between the second rib 470 of the second continuous flange 248 and the exterior of the second body 240. The channel 372 may house a sealing element 474 (e.g., a foam or the like). When assembled and in use, the first rib 476 compresses the sealing element 474 housed within the channel 372 of the second body 240 to create a seal therebetween when the first continuous flange 246 and the second continuous flange 248 are coupled together and secured.

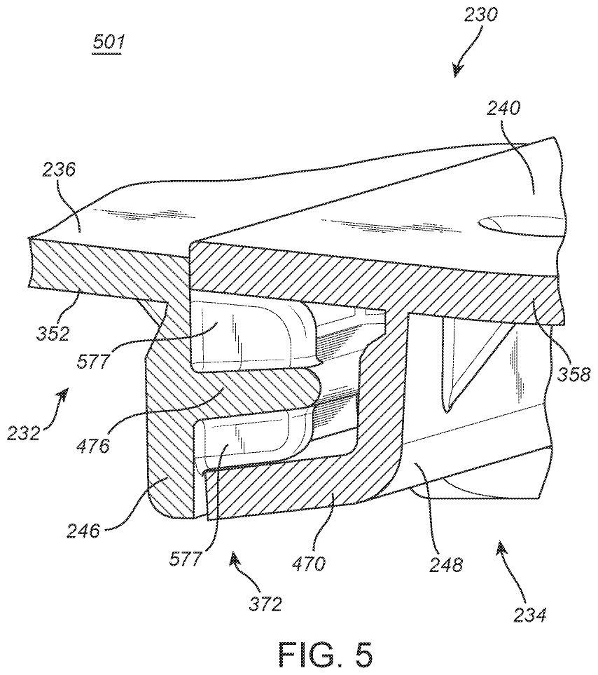

Referring particularly to FIG. 5, a cross-section of a bottom portion of an additional or alternative exemplary embodiment of a bifurcated storage compartment is illustrated showing steering ribs thereof, in accordance with aspects of the present subject matter. As shown and in some embodiments, the first continuous flange 246 may include a plurality of steering ribs 577 adapted to steer the first continuous flange 246 and the second continuous flange 248 together as the first container segment 232 and the second container segment 234 are placed together. Generally, injection molded parts are susceptible to warpage and distortion that may make assembling the first container segment 232 and the second container segment 234 difficult. Thus, the first continuous flange 246 may include the steering ribs 577 protruding from the first continuous flange 246. Additionally or alternatively, the steering ribs 577 may extend from the first rib 476. Generally, a plurality of steering ribs 577 may be spaced along the first continuous flange 246 and/or the first rib 476 with some distance in between. As the first container segment 232 and the second container segment 234 are assembled, the steering ribs 577 may be received by the same channel 372 defined by the second rib 470 and housing the sealing element 474 (omitted from FIG. 5 for clarity) in order steer the first continuous flange 246 and the second continuous flange 248 together and ensure an even interface between the two parts.

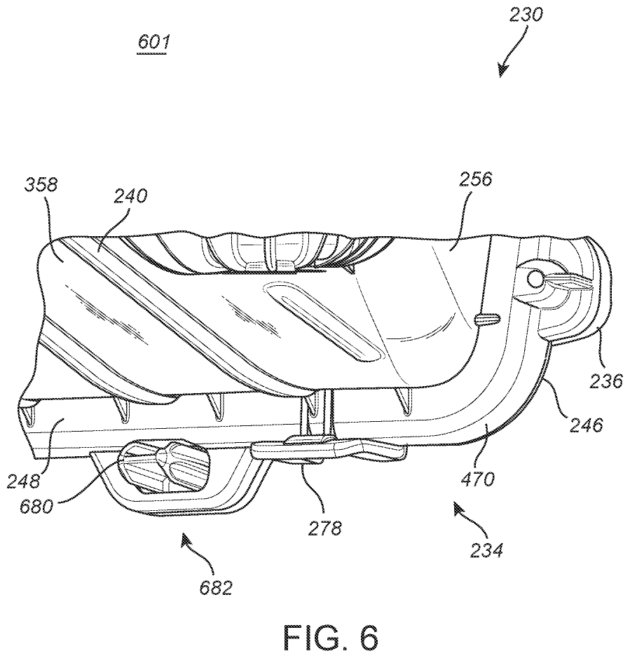

FIG. 6 illustrates a bottom perspective view of an exemplary embodiment of a bifurcated storage compartment, in accordance with aspects of the present subject matter. As shown and in some embodiments, the first continuous flange 246 may include at least one steering pin 680, and the second continuous flange 248 may define at least one guide hole or guide cavity (guide cavity 682) configured to receive the at least one steering pin 680. Generally, the steering pin(s) 680 and guide cavity (ies) 682 may be operable together to ensure a proper alignment as the first continuous flange 246 and the second continuous flange 248 are coupled together. Furthermore, the steering pin(s) 680 and guide cavity (ies) 682 may assist in at least partially deforming the first container segment 232 and the second container segment 234 as the first continuous flange 246 and the second continuous flange 248 are brought together. It should be appreciated that the steering pin(s) 680 assist in assembling the first continuous flange 246 and the second continuous flange 248 prior to engagement of steering ribs 577 within the channel 372, as described above, in order to avoid over constraining such parts. Thus, the steering pin(s) 680 may be configured to not steer or guide the first continuous flange 246 and the second continuous flange 248 together once the steering ribs 577 engage with the second rib 470 and/or the exterior of the second body 240 defining the channel 372.

Referring now to FIGS. 2 and 6 and in some embodiments, the first continuous flange 246 may include a plurality of clips 278 configured to retain the second continuous flange 248 when the first continuous flange 246 and the second continuous flange 248 are coupled together. For instance, the exterior surface of the second continuous flange 248 and/or the second body 240 may define one or more protrusions or recessions operable with the clips 278 to selectively secure the first continuous flange 246 and the second continuous flange 248 together. In additional or alternative embodiments, the first continuous flange 246 may be secured or attached to the second continuous flange 248 utilizing similar clips of the second continuous flange 248 and/or one or more fasteners (e.g., screws, bolts, rivets, clamps, or the like).

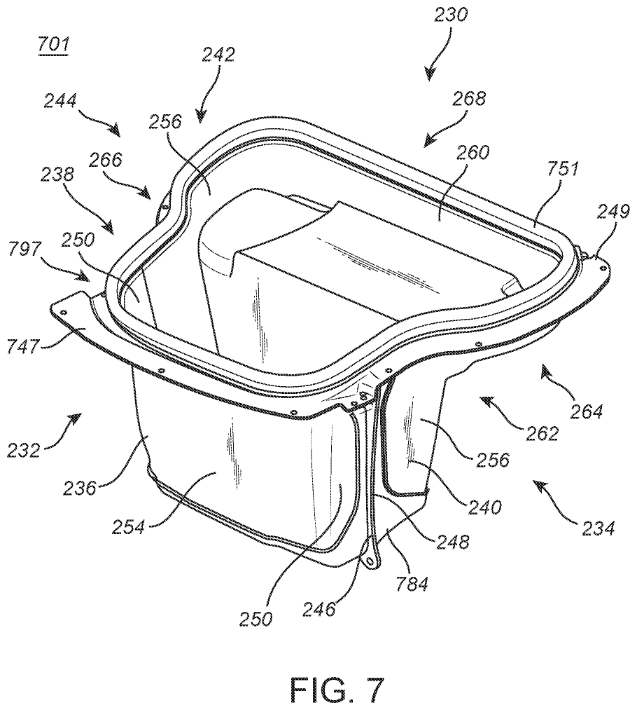

Referring now to FIGS. 7-12, schematic views of exemplary embodiments of another bifurcated storage compartment are illustrated in accordance with aspects of the present subject matter. The bifurcated storage compartment 230 may be incorporated into an electric vehicle or hybrid vehicle (vehicle 10) as described above in reference to FIG. 1, or alternatively may be integrated into any other suitable vehicle. In various embodiments, the bifurcated storage compartment 230 may be configured as a frunk 22. However, additional or alternative embodiments of the bifurcated storage compartment 230 may be configured for the back space 24 under the trunk door 26 (e.g., the trunk 28) or another suitable free space of the vehicle 10 configured for cargo storage.

The embodiments of the bifurcated storage compartment 230 of FIGS. 7-12 may generally be configured similar to the embodiments of the bifurcated storage compartment 230 described with reference to FIGS. 2-6. For instance, the bifurcated storage compartment 230 may include a first container segment 232 having a first body 236 defining a first recessed 238 and a second container segment 234 having a second body 240 defining a second recessed interior 242. The first container segment 232 and the second container segment 234 may each include a first continuous flange 246 or a second continuous flange 248 (shown enclosed the bottom load carrier 784 in FIGS. 7, 8, 10, and 12), respectively, such that the first continuous flange 246 and the second continuous flange 248 may be coupled together to form a cavity 244 from the first recessed interior 238 and the second recessed interior 242. However, for the depicted embodiments of FIGS. 7-12, the bifurcated storage compartment 230 may include a bottom load carrier 784 configured to secure the first container segment 232 and the second container segment 234 together.

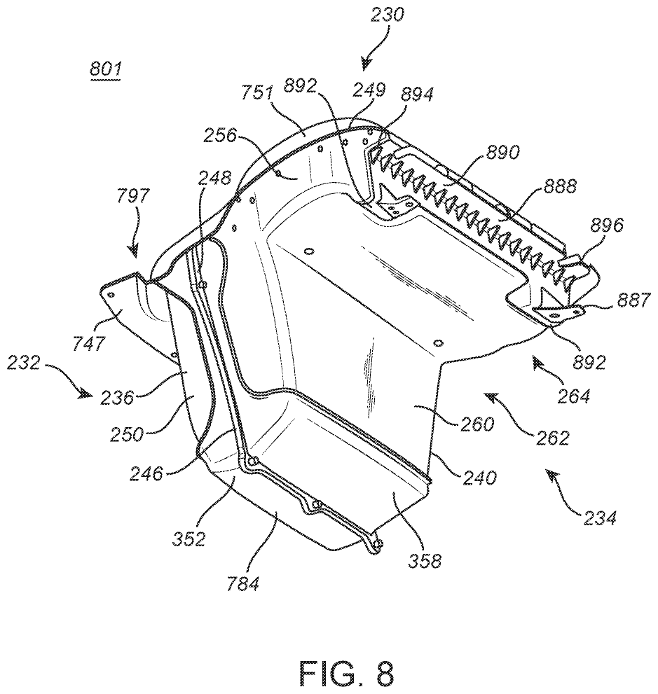

Referring now particularly to FIGS. 7 and 8, FIG. 7 illustrates a top perspective view of a bifurcated storage compartment including a bottom load carrier, in accordance with aspects of the present subject matter, and FIG. 8 illustrates a bottom perspective view of a bifurcated storage compartment including a bottom load carrier, in accordance with aspects of the present subject matter. As depicted, the first continuous flange 246 and the second continuous flange 248 (shown enclosed the bottom load carrier 784 in FIGS. 7, 8, 10, and 12) may be received by the bottom load carrier 784 in order to assemble the first container segment 232 and the second container segment 234 together to form the bifurcated storage compartment 230. For example, the first continuous flange 246 and the second continuous flange 248 may be slid into or otherwise received within one or more slots defined in the bottom load carrier 784. Furthermore, the bottom load carrier 784 may be configured to control the size of or eliminate one or more gaps between the first continuous flange 246 and the second continuous flange 248, e.g., such that the flanges 246, 248 are flush when the bifurcated storage compartment 230 is assembled.

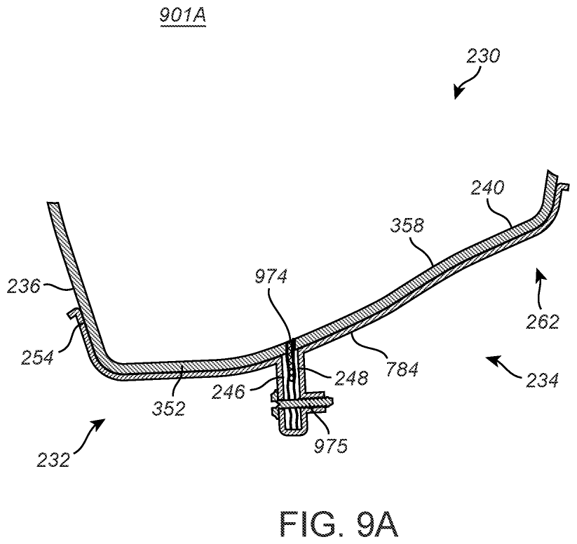

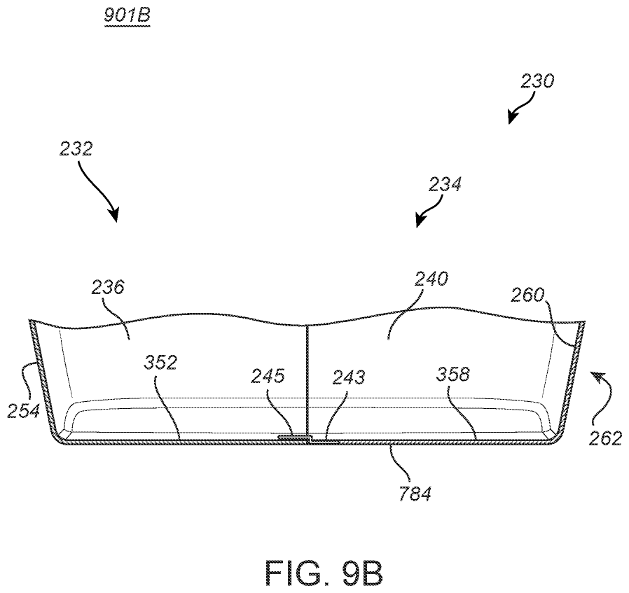

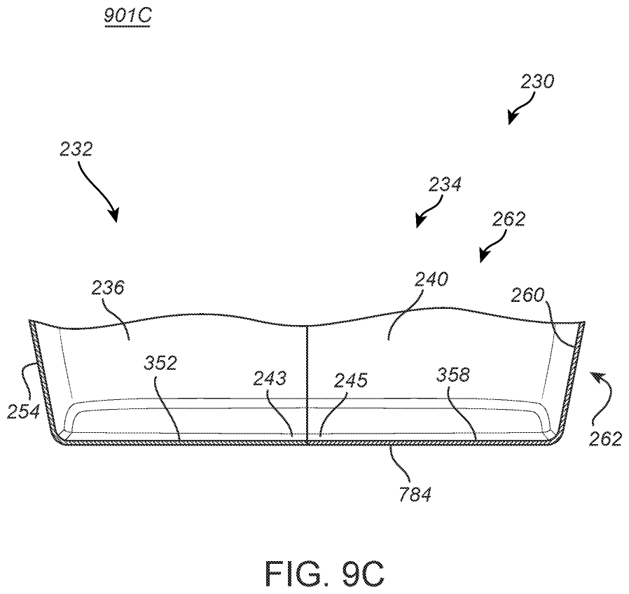

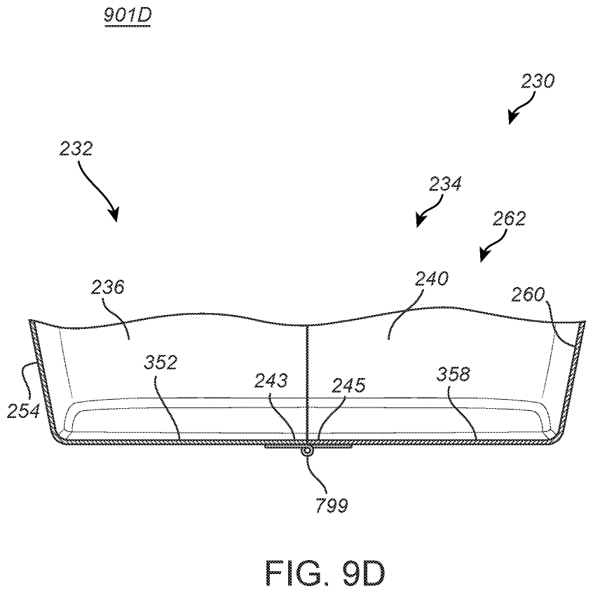

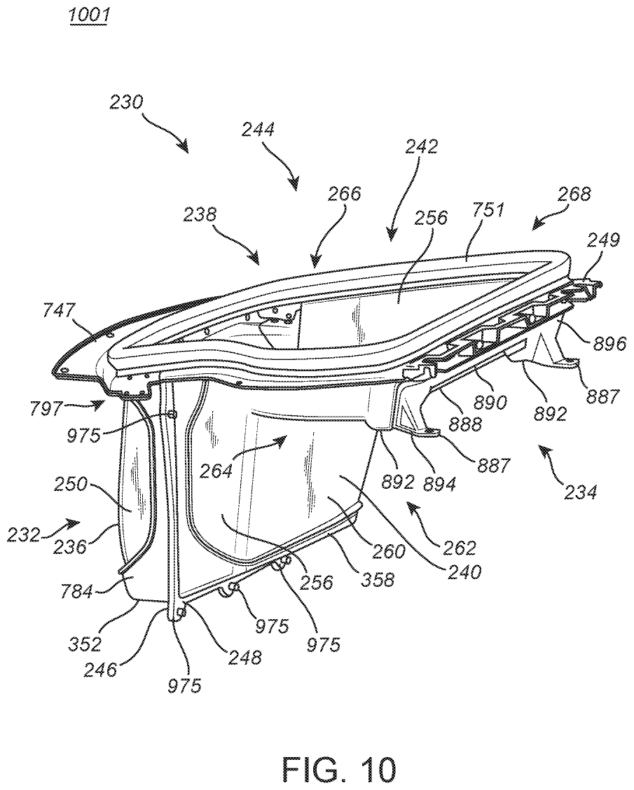

Referring now to FIG. 9A, a cross-section of one exemplary embodiment of a bifurcated storage compartment including a bottom load carrier with a sealing element is illustrated, in accordance with aspects of the present subject matter. Also with reference to FIG. 10, a top, back perspective view of a bifurcated storage compartment including a bottom load carrier is illustrated in accordance with aspects of the present subject matter. As shown particularly in FIG. 9A and in some embodiments, the bifurcated storage compartment 230 may further include at least one adhesive tape, foam, glue, or the like (sealing strip 974) configured to be positioned between the first continuous flange 246 and the second continuous flange 248. In some embodiments, one or more sealing strips 974 may be provided for sides of the bottom load carrier 784, e.g., a sealing strip(s) 974 provided for the first and second continuous flanges 246, 248 along the sidewalls 250, 256; a sealing strip(s) 974 may be provided for the first and second continuous flanges 246, 248 along the other of the sidewalls 250, 256; and a sealing strip(s) 974 may be provided for the first and second continuous flanges 246, 248 along the bottom walls 352, 358. In various embodiments, when the first continuous flange 246 and the second continuous flange 248 are coupled together and secured, the bottom load carrier 784 may apply compression to the sealing strip(s) 974 arranged between the first continuous flange 246 and the second continuous flange 248 such that a seal is created therebetween.

In some embodiments, one or more fasteners 975 (e.g., screws, bolts, clips, or the like) may be utilized to increase the compression provided by the bottom load carrier 784 on the first body 236 and the second body 240. In some embodiments, three fasteners may be provided along a bottom of the bottom load carrier 784 (see fasteners 975 of FIG. 10) to assemble the first body 236, the second body 240, and the bottom load carrier 784 together. For instance, a fastener 975 may be provided on each end of the bottom load carrier 784 proximate to the bottom walls 352, 358 and the respective sidewall 250, 256 of the opposing sidewalls 250, 256 of the first body 236 and the second body 240, respectively. The third fastener 975 may be provided along the bottom load carrier 784 between the bottom-end fasteners 975, such as approximately in the middle of the bottom portion of the bottom load carrier 784. Furthermore, some embodiments may include a fastener 975 provided along each of the sides of the bottom load carrier 784. For example, a fastener 975 may be provided along each side of the bottom load carrier 784 to couple the first continuous flange 246 and the second continuous flange 248 together proximate to the top of the sidewalls 250, 256 (see fasteners 975 of FIG. 10). Generally, the fastener(s) 975 may be threaded or pushed through each of the bottom load carrier 784, the first continuous flange 246, and the second continuous flange 248 and tightened or secured in order to provide more compression on the sealing strip(s) 974 and thus an improved sealing interface between the first body 236 the second body 240.

Referring now to FIGS. 9B-9D, cross-sections of exemplary embodiments of bifurcated storage compartments without flanges and including bottom load carriers are illustrated, in accordance with aspects of the present subject matter. Particularly, FIG. 9B illustrates an embodiment of a bifurcated storage compartment where the edges of the container segments are overlaid when the container segments are coupled together with a bottom load carrier. For example, the first body 236 may include a first edge 243 configured to extend within the interior of the second body 240 (e.g., within the second recessed interior 242) or extend around the exterior surface of the second body 240 (e.g., between the exterior surface of the second body 240 and the bottom load carrier 784) when the first container segment 232 and the second container segment 234 are received within the bottom load carrier 784 and assembled to form the bifurcated storage compartment 230. Similarly and as shown in FIG. 9B, the second body 240 may include a second edge 245 configured to extend within the interior of the first body 236 (e.g., within the first recessed interior 238) or extend around the exterior surface of the first body 236 (e.g., between the exterior surface of the first body 236 and the bottom load carrier 784) when the first container segment 232 and the second container segment 234 are received within the bottom load carrier 784 and assembled to form the bifurcated storage compartment 230. FIG. 9C illustrates an embodiment of a bifurcated storage compartment where the edges of the container segments abut when the container segments are coupled together with a bottom load carrier. For example, the first body 236 may include a first edge 243 configured to abut (e.g., meet edge-to-edge with) with a second edge 245 of the second body 240 when the first container segment 232 and the second container segment 234 are received within the bottom load carrier 784 and assembled to form the bifurcated storage compartment 230.

Referring now to FIG. 9D, an exemplary embodiment of a bifurcated storage compartment is illustrated where one or more hinges are coupled to the bottom edges of the container segments when the container segments are coupled together with a bottom load carrier. For example, one or more hinges 799 (e.g., separately formed hinges) may be coupled between the first edge 243 of the bottom wall 352 of the first body 236 and the second edge 245 of the bottom wall 358 of the second body 240. Thus, the hinge(s) 799 may couple together the first body 236 and the second body 240 and allow the first segment 232 and the second segment 234 to fold relative to one another (e.g., along the respective bottom edges 243, 245) prior to being received within the bottom load carrier 784 and assembled to form the bifurcated storage compartment 230.

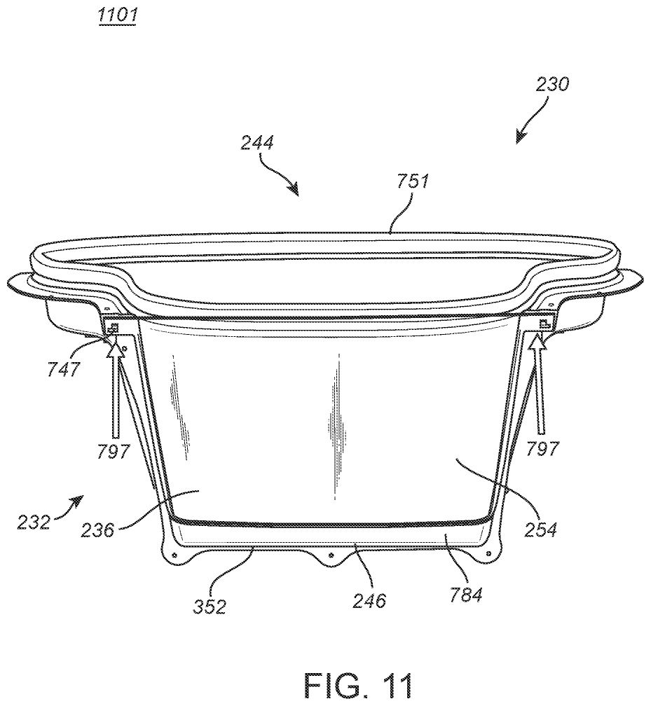

FIG. 11 illustrates a front view of an exemplary embodiment of a bifurcated storage compartment where the first body of the first container segment includes a top flange, in accordance with aspects of the present subject matter. Referring now generally to FIGS. 7, 8, 10, and 11, in several embodiments the first body 237 of the first container segment 232 may include one or more first top flanges 747 extending from at least a top edge of the first sidewalls 250. In some embodiments, and as shown, a continuous first top flange 747 may extend from each of one first sidewall 250 of the first sidewalls 250, the front wall 254, and the other first sidewall 250 of the first sidewalls 250. In exemplary embodiments and as shown, the first top flange(s) 747 may extend approximately perpendicular to an exterior surface of each of the first sidewalls 250, respectively, and/or to an exterior surface of the front wall 254.

Each first flange 747 extending from the top edge of the first sidewalls 250 (or the portions of the first flange 747 extending from the top edge of the first sidewalls 250) may define one or more first retention cavities or holes 797. The bottom load carrier 784 may include a plurality of protrusions (reference number omitted for clarity) positioned at the top of the bottom load carrier 784 and towards the first body 236 when the bottom load carrier 784 is assembled with the first container segment 232 and the second container segment 234 to form the bifurcated storage compartment 230. When assembled, the protrusions of the bottom load carrier 784 may be received within the first retention cavities or holes 797 defined by the first top flange(s) 747 to secure the bottom load carrier 784 to the first sidewalls 250 of the first body 237. Thus and as illustrated, the first retention cavities or holes 797 and the protrusions of the bottom load carrier 784 are configured such that the bottom load carrier 784 may be snapped onto the first body 237 of the first container segment 232.

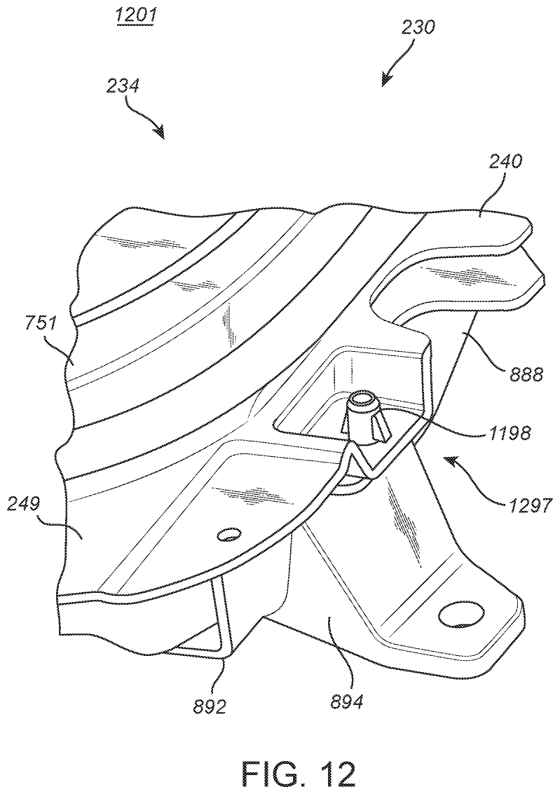

FIG. 12 illustrates a top perspective view of an exemplary embodiment of a bifurcated storage compartment with a top flange coupled to a top load carrier, in accordance with aspects of the present subject matter. Referring now generally to FIGS. 7, 8, 10, and 12, some embodiments of the bifurcated storage compartment 230 may further include a top load carrier 888 configured to couple to the second body 240 proximate to a top edge of the back wall 260. In several embodiments, the top load carrier 888, when assembled with the second container segment 234, extends between the opposing second sidewalls 256 and is coupled to the second body 240 to secure the second body 240 to the vehicle 10. The bottom load carrier 784 and the top load carrier 888 are generally configured to attach or be secured to one or more structure components of the vehicle 10 (e.g., one more portions of the frame or the body of the vehicle 10). For example, the top load carrier 888 may include one or more attachment structures 887 configured to allow the top load carrier 888 to be secured to the vehicle 10. In some embodiments, the top load carrier 888 may be coupled, secured, or otherwise attached the vehicle 10 prior to instillation of the first container segment 232 and/or the second container segment 234. Subsequent to installation of the top load carrier 888 in the vehicle 10, the bifurcated storage compartment 230 (e.g., the second container segment 234) may be secured to the top load carrier 888, as described herein.

In some embodiments, the bottom load carrier 784 may similarly include one or more attachment structures suitable to secure the bottom load carrier 784 to the vehicle 10 (e.g., one or more portions of the body and/or the frame of the vehicle 10). In additional or alternative embodiments, the vehicle 10 (e.g., the body and/or frame thereof) may define a cavity, recession, or the like with a shape complementary to the shape defined by the bottom portion of the bottom load carrier 784 and/or at least a bottom portion of the assembled first body 236 and the second body 240. It should be appreciated that the bottom load carrier 784 may secured to the vehicle 10 when the bottom load carrier 784 is received within such cavity or recession of the vehicle 10. Thus, the load carriers 784, 888 support the load resulting from cargo stored in the cavity 244 of the bifurcated storage compartment 230. Additionally or alternatively, the load carriers 784, 888 may improve the structural integrity of the bifurcated storage compartment 230 during use, especially in situations where heavy cargo is stored in the cavity 244. For example, the bottom load carrier 784 that acts to support the loads experienced by the bifurcated storage compartment 230 may allow for the other components thereof (e.g., the first container segment 232 and/or the second container segment 234) to be formed from thinner materials, lighter weight materials, and/or unconventional materials such as one or more bioplastics.

In some such embodiments, the top load carrier 888 may include an elongate body 890 with a first snap hook 892 (e.g., clip, C-clip, or the like) proximate to a first end 894 of the elongate body 890 and a second snap hook 892 (e.g., clip, C-clip, or the like) proximate to a second end 896 of the elongate body 890. The first snap hook 892 may be configured to be coupled to the back wall 260 proximate to the top edge of the back wall 260 and one sidewall 256 of the opposing second sidewalls 256. The second snap hook 892 may be configured to be coupled to the back wall 260 proximate to the top edge of the back wall 260 and the other sidewall 256 of the opposing second sidewalls 256. Generally, the back wall 260 may define a conformed portion for each snap hook 892 (e.g., clip, C-clip, or the like) of the top load carrier 888. For example, portions of the exterior surface of the back wall 260 may each be formed with a shape suitable to retain the associated snap hooks 892 (e.g., clips, C-clips, or the like) in order to at least partially secure the top load carrier 888 to the second container segment 234.

As illustrated and in some embodiments, the second body 240 of the second container segment 234 may include a second top flange 249 (see also FIGS. 2 and 3) extending from at least a top edge of the back wall 260. In some embodiments, and as shown, a continuous second top flange 249 may extend from each of one second sidewall 256 of the second sidewalls 256, the back wall 260, and the other second sidewall 256 of the second sidewalls 256. In exemplary embodiments and as shown, the second top flange(s) 747 may extend approximately perpendicular to an exterior surface of the back wall 260 and/or the exterior surface of each of the second sidewalls 256, respectively.

As shown particularly in FIG. 12, the second top flange(s) 249 may define a plurality of second retention cavities or holes 1297. The top load carrier 888 may include a plurality of protrusions 1198 positioned between the first and second ends 894, 896 of the elongate body 890. When the top load carrier 888 is coupled to the back wall 260 of the second body 240, the plurality of protrusions 1198 of the top load carrier 888 may be received within the second retention cavities or holes 1297 defined by the second top flange 249 to secure the top load carrier 888 to the back wall 260. Thus and as illustrated, the snap hooks 892 (e.g., clips, C-clips, or the like) and protrusions 1198 are configured such that the top load carrier 888 may be snapped onto the second body 240 of the second container segment 234. Furthermore, the snap hooks 892 and protrusions 1198 may be configured such that the top load carrier 888 may be snapped off of the second body 240 of the second container segment 234 and separately disposed of from the other components of the bifurcated storage compartment 230 (e.g., disposed of or recycled with a process that is different than one or more recycling processes suitable for the first body 236 and/or the second body 240).

In some embodiments, the bottom load carrier 784 and/or the top load carrier 888 may include or be formed from a plastic material, such as a PPGF plastic material. Advantageously, the snap hooks 892 (e.g., clips, C-clips, or the like) and protrusions 1198 may also allow the top load carrier 888 to be easily removed such that the second container segment 234 and/or the top load carrier 888 may be recycled utilizing the same or different recycling processes. Similarly, the bottom load carrier 784, the first retention cavities or holes 797, protrusions of the bottom load carrier 784 associated with the first retention cavities or holes 797, and/or the fastener(s) 975 may allow for the bottom load carrier 784 to be easily removed such that the first container segment 232, the second container segment 234, and/or the bottom load carrier 784 may be recycled utilizing the same or different recycling processes.

Referring now to FIGS. 7, 8, 10, 11, and 12 and in some embodiments, the bifurcated storage compartment 230 may further include one or more top seals 751 arranged along a top edge of the bifurcated storage compartment 230 (e.g., the top edge of the first container segment 232 and the second container segment 234 that together define the cavity 244 of the bifurcated storage compartment 230). In some embodiments one or more monolithic top seals 751 may be coupled to the top edges of the bifurcated storage compartment 230 and arranged to circumscribe a perimeter of the cavity 244. For example, the top edges of the bifurcated storage compartment 230 (e.g., the top edge of the first body 236 or the top edges of the walls 250, 254 thereof and the top edges of the second body 240 or the top edges of the walls 256, 260 thereof) and the top seal(s) 751 may configured such that the top edge(s) is received within the top seal(s) 751, the top seal(s) 751 are clicked onto the top edge(s), and/or the top seal(s) 751 are otherwise fixed to the top edge(s) of the bifurcated storage compartment 230.

For example and in one embodiment, a continuous top seal 751 may be fixed to the top edge(s) of the first body 236 and the top edge(s) of the second body 240 when the first container segment 232 and the second container segment 234 are assembled into the bifurcated storage compartment 230. In other configurations, a first top seal 751 may be fixed to the top edge(s) of the first body 236, and a second top seal 751 may be fixed to the top edge(s) of the second body 240, prior to or after the segments 232, 234 are assembled into the bifurcated storage compartment 230. Generally, the top seal(s) 751 are configured such that when a hood of the vehicle 10 (e.g., the front hood 20) is closed, the top seal(s) 751 form a watertight seal between the top edges of the bifurcated storage compartment 230 and the associated hood or a hood seal(s) of the vehicle 10. While described generally relative to a frunk 22 where the seal(s) 751 is operable with the front hood 20, it should be appreciated that the present disclosure is equally applicable to any storage space (e.g., back storage space 24), such as trunk 28, and that the seal(s) 751 may be operable with any associated closure thereof (e.g., the trunk door 26 and/or one or seals associated with the trunk door 26).

Referring now to FIGS. 13-17, schematic views of exemplary embodiments of a split-configuration storage compartment are illustrated in accordance with aspects of the present subject matter. A split-configuration storage compartment 1330 may be incorporated into an electric vehicle or hybrid vehicle (vehicle 10) as described above in reference to FIG. 1, or alternatively may be integrated into any other suitable vehicle. In various embodiments, the split-configuration storage compartment 1330 may be configured as a frunk 22. However, additional or alternative embodiments of split-configuration storage compartment 1330 may be configured for the back space 24 under the trunk door 26 (e.g., a trunk 28) or another suitable free space of the vehicle 10 configured for cargo storage. The embodiments of the split-configuration storage compartment 1330 of FIGS. 13-17 may generally be configured similar to the embodiments of the bifurcated storage compartment 230 described with reference to FIGS. 2-6 and/or the embodiments of the bifurcated storage compartment 230 described with reference to FIGS. 7-12. For instance, the split-configuration storage compartment 1330 may include a first container segment having a first body 236 defining a first recessed 238 and a second container segment having a second body 240 defining a second recessed interior 242.

However, rather than entirely separate container segments 232, 234 as described with respect to FIGS. 2-12, the split-configuration storage compartment 1330 of FIGS. 13-17 may generally include first split-container segment 1332 and a second split-container segment 1334 joined at corresponding bottom portions (e.g., bottom wall 352 and bottom wall 358) by a living hinge 1399. Furthermore, rather than the first container segment 232 and the second container segment 234 each including a first continuous flange 246 or a second continuous flange 248, respectively, the first split-container segment 1332 may include a plurality of first flanges 1346, and the second split-container segment 1334 may include a plurality of second flanges 1348. Similar to the bifurcated storage compartment 230 described with reference to FIGS. 7-12, the first flanges 1346 and the second flanges 1348 may be coupled together to form a cavity 244 from the first recessed interior 238 and the second recessed interior 242. Furthermore, for the depicted embodiments of FIGS. 13-17, the split-configuration storage compartment 1330 may include a bottom load carrier 784 configured to secure the first split-container segment 1332 and the second split-container segment 1334 together, as described generally with respect to the embodiments of FIGS. 7-12.

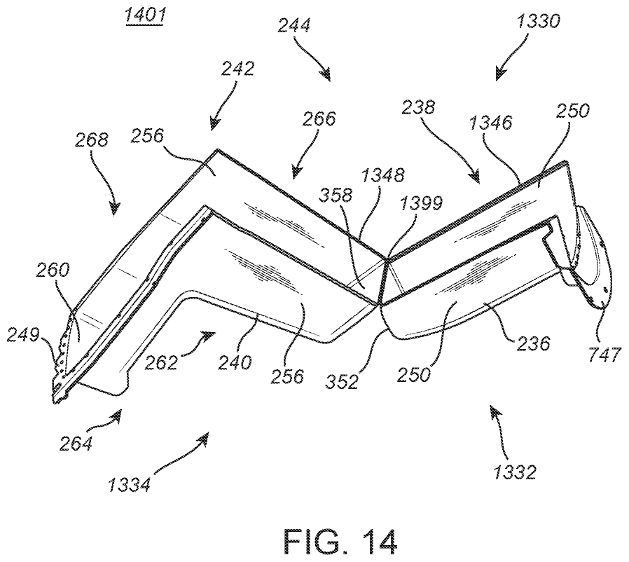

Referring now particularly to FIGS. 13 and 14, FIG. 13 illustrates a bottom perspective view of a split-configuration storage compartment including a living hinge in a closed configuration, in accordance with aspects of the present subject matter, and FIG. 14 illustrates a top perspective view of a split-configuration storage compartment including a living hinge in an open configuration, in accordance with aspects of the present subject matter. Embodiments of the split-configuration storage compartment 1330, as described herein, generally include a living hinge 1399 positioned between and coupling the first body 236 to the second body 240 such that the first split-container segment 1332 and the second split-container segment 1334 each extend from the living hinge 1399 to form the split-configuration storage compartment 1330. The first split-container segment 1332 and the second split-container segment 1334 may be folded together and then coupled together to form the cavity 244 from the first recessed interior 238 and the second recessed interior 242. The formed cavity 244 may be configured to store items or cargo.

As illustrated and in some embodiments, the first split-container segment 1332 may include the first flanges 1346. For example, the first flanges 1346 may include a pair of first flanges 1346, each first flanges 1346 extending from an exterior of the first body 236 along the opposing first sidewalls 250, such that the pair of opposing first flanges 1346 at least partially defines a perimeter of the first recessed interior 238. Furthermore and for some embodiments, the pair of opposing first flanges 1346 and the living hinge 1399 may at least partially define the perimeter of the first recessed interior 238. As shown, the second split-container segment 1334 may include the second flanges 1348. For instance, the second flanges 1348 may likewise include a pair of second flanges 1348, each second flange 1348 extending from an exterior of the second body 240 along the opposing second sidewalls 256, such that the pair of opposing second flanges 1348 at least partially defines a perimeter of the second recessed interior 242.

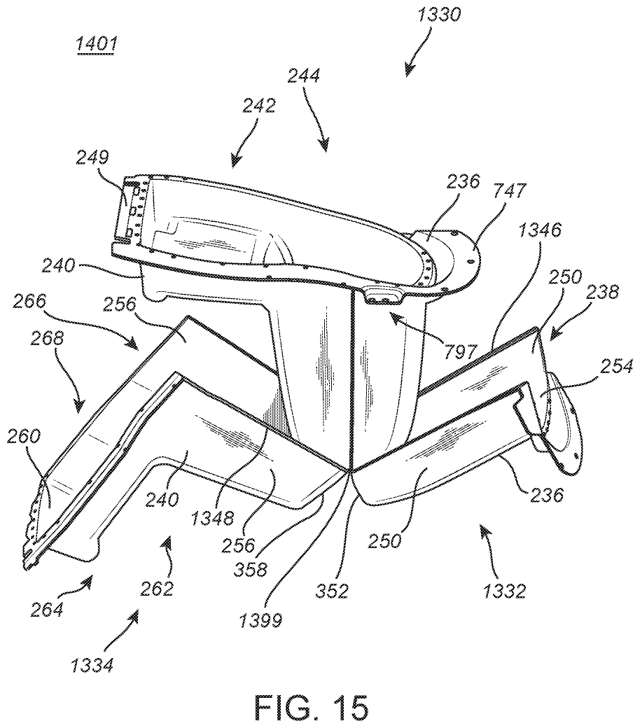

Referring now also to FIG. 15, a top perspective view of an embodiment of a split-configuration storage compartment including a living hinge is illustrated in both an open configuration and a closed configuration, in accordance with aspects of the present subject matter. As illustrated, the first flanges 1346 and second flanges 1348 may define complementary profiles such that the first flanges 1346 and the second flanges 1348 may be coupled together to form the cavity 244 from the first recessed interior 238 and the second recessed interior 242. Thus and as shown, the first split-container segment 1332 and the second split-container segment 1334 may be folded together from the open configuration to the closed configuration of the split-configuration storage compartment 1330. Thereafter, the first flanges 1346 and second flanges 1348 may be coupled and secured together (e.g., utilizing one or more clips, fasteners, load carriers, or the like as described herein).

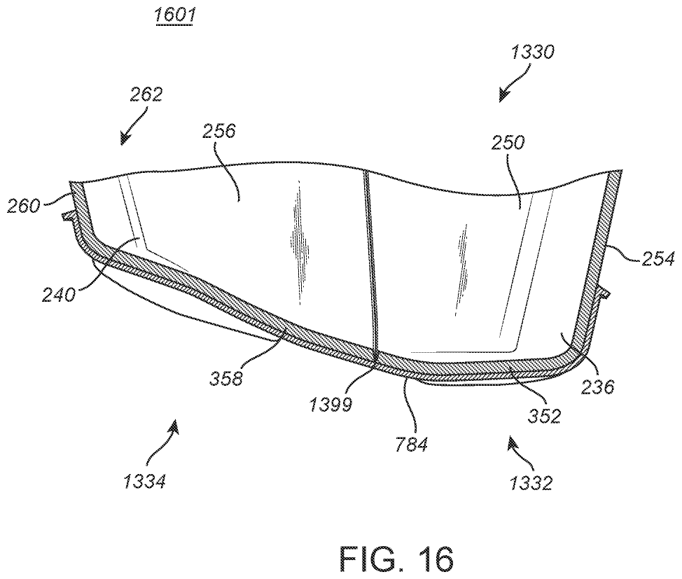

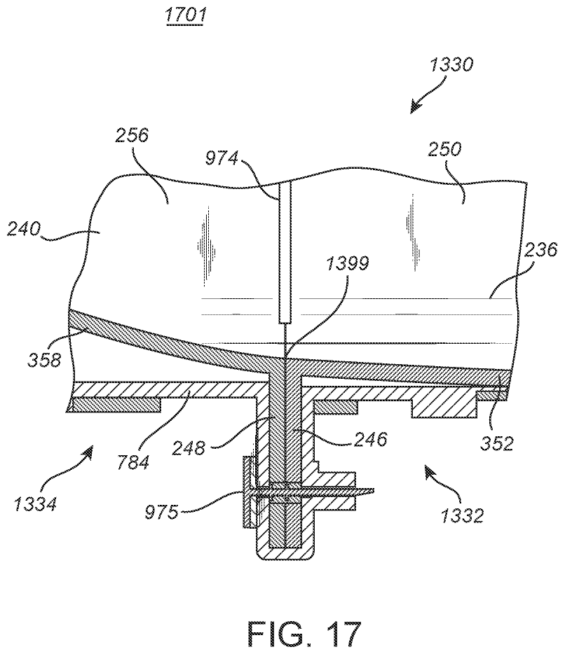

Referring now to FIGS. 16 and 17, FIG. 16 illustrates cross-section of one exemplary embodiment of a split-configuration storage compartment including a bottom load carrier, in accordance with aspects of the present subject matter; and FIG. 17 illustrates a cross-section of another exemplary embodiment of a split-configuration storage compartment including a bottom load carrier with a sealing element, in accordance with aspects of the present subject matter. As shown, the split-configuration storage compartment 1330 may further include or be used in conjunction with a bottom load carrier 784 configured to enclose the first flanges 1346 and second flanges 1348 when the first flanges 1346 and the second flanges 1348 are coupled together and secured, as described herein. Additionally or alternatively, it should be appreciated that the first flanges 1346 and the second flanges 1348 may be secured together utilizing one or more clips (e.g., clips 278 as described with respect to FIGS. 2 and 6) and/or the first flanges 1346 and the second flanges 1348 may be directly secured together utilizing one or more fasteners (e.g., screws, bolts, rivets, clamps, or the like).

As shown particularly in FIG. 17 and in some embodiments, the split-configuration storage compartment 1330 may also include two or more sealing strips 974, as described herein. Each sealing strip 974 may generally be positioned between one first flanges 1346 of the first flanges 1346 and one second flange 1348 of the second flanges 1348. Thus, when the first flanges 1346 and the second flanges 1348 are coupled together and secured, the sealing strips 974 in combination with the living hinge 1399 may create a seal between the first container segment 232 and the second container segment 234. For example and as shown in the embodiment of FIG. 17, the bottom load carrier 784 may apply compression to the sealing strips 974 arranged between the first flanges 1346 and the second flanges 1348 such that a seal is created therebetween on each side of the split-configuration storage compartment 1330 (e.g., a first seal between one first flange 1346 and one second flange 1348 proximate to one of each of the sidewalls 250, 256 and a second seal between an opposing first flange 1346 and opposing second flange 1348 proximate to opposing sidewall 250, 256 of each of the sidewalls 250, 256). Additionally or alternatively, some embodiments may include one or more fasteners 975 (e.g., screws, bolts, clips, or the like), as described herein, utilized to increase the compression provided by the bottom load carrier 784 on the first body 236 and the second body 240. For example, the bottom load carrier 784 may secure the first split-container segment 1332 and the second split-container segment 1334 utilizing three or more fasteners 975 arranged along a bottom of the bottom load carrier 784, such as utilizing five fasteners 975, as described generally with respect to FIG. 10 above.

Referring again generally to FIGS. 13-17 and in some embodiments, the entire split-configuration storage compartment 1330 (e.g., the first body 236 and the second body 240) may be simultaneously pressed into a tool or mold from one or more plastic materials, as described herein, such that the living hinge 1399 of the plastic material(s) still connects the first split-container segment 1332 and the second split-container segment 1334. Additionally or alternatively, the first split-container segment 1332 (e.g., the first body 236) and the second split-container segment 1334 (e.g., the second body 240) may be pressed sequentially from the plastic material(s) such that the living hinge 1399 of the plastic material(s) still connects the first split-container segment 1332 and the second split-container segment 1334. The plastic material(s) used to form the first split-container segment 1332 and the second split-container segment 1334 may include one or more of a PET material or bioplastic materials, as described herein.

For example, the split-configuration storage compartment 1330 may be pressed from the plastic material(s) (e.g., one or more hot pressed plastic materials, such a hot-pressed PET material, one or more hot pressed bioplastics, and/or other suitable polymers) in the open arrangement of the first split-container segment 1332 and the second split-container segment 1334. The finished split-configuration storage compartment 1330 may be shipped as an open part and/or stacked with other split-configuration storage compartments 1330. The split-configuration storage compartment 1330 may be folded into the closed position with the sealing strips 974 arranged between the first flanges 1346 and the second flanges 1348. The folded split-configuration storage compartment 1330 may then be slid into the bottom load carrier 784 in order to secure t the first split-container segment 1332 and the second split-container segment 1334 together, as described herein, prior to installation in the vehicle 10.

It should be appreciated that the stackable nature of the split-configuration storage compartment 1330 allows for the same improved transportation logistics and cost savings while reducing the environmental impact of such transportation as described above with respect to the embodiments of the bifurcated storage compartment 230. Additionally or alternatively, the first body 236 and the second body 240 of the split-configuration storage compartment 1330 may be formed from a recyclable material(s) to promote sustainability. Thus, disclosed embodiments of the split-configuration storage compartment 1330 may be configured for disassembly of the constituent components in order to allow for sorting and separate recycling of such components. For example, the first split-container segment 1332 and the second split-container segment 1334 may be recycled utilizing a first process, e.g., a recycling process suitable for PET plastic and/or a recycling process suitable for bioplastics. Additionally or alternatively, any associated load carrier component(s) (e.g., the bottom load carrier 784) of the split-configuration storage compartment 1330 may be separately disposed of or recycled utilizing a different recycling process, e.g., a recycling process suitable for the material of the bottom load carrier 784, such as a recycling process suitable for a PPGF plastic material. Furthermore, separately pressing the first recessed interior 238 into the first body 236 of the first split-container segment 1332 and the second recessed interior 242 into the second body 240 of the second split-container segment 1334 may generally allow for reduced draft angles and a larger cavity volume of the resulting cavity 244 in comparison to the storage cavity of a monolithic body storage compartment and/or frunk.

Although the present disclosure is illustrated and described herein with reference to illustrative embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. A bifurcated storage compartment for a vehicle, the bifurcated storage compartment comprising:
a first container segment configured to be secured to the vehicle and including:
a first body defining a first recessed interior; and
a second container segment configured to be secured to the vehicle and including:
a second body defining a second recessed interior,
wherein the first container segment and the second container segment define complementary profiles such that the first container segment and the second container segment may be coupled together to form a cavity from the first recessed interior and the second recessed interior, the cavity configured to store items or cargo.

2. The bifurcated storage compartment of claim 1, wherein the first body includes at least one first flange extending from an exterior of the first body such that the at least one first flange at least partially defines a perimeter of the first recessed interior, wherein the second body includes at least one second flange extending from an exterior of the second body such that the at least one second flange at least partially defines a perimeter of the second recessed interior, and wherein the at least one first flange and the at least one second flange define complementary profiles such that the at least one first flange and the at least one second flange may be coupled together to form the cavity from the first recessed interior and the second recessed interior.

3. The bifurcated storage compartment of claim 2, wherein the at least one first flange is configured as a first continuous flange extending from the exterior of the first body and defining the perimeter of the first recessed interior.

4. The bifurcated storage compartment of claim 3, wherein the at least one second flange is configured as a second continuous flange extending from the exterior of the second body and defining the perimeter of the second recessed interior.

5. The bifurcated storage compartment of claim 4, wherein the first body of the first container segment includes opposing first sidewalls, a first bottom wall extending between the opposing first sidewalls, and a front wall extending from the first bottom wall and between the opposing first sidewalls, and the second body of the second container segment includes opposing second sidewalls, a second bottom wall extending between the opposing second sidewalls, and a back wall extending from the second bottom wall and between the opposing second sidewalls,
wherein the first continuous flange extends from an exterior of each of the opposing first sidewalls and the first bottom wall, and
wherein the second continuous flange extends from an exterior of each of the opposing second sidewalls and the second bottom wall.

6. The bifurcated storage compartment of claim 5, further comprising:
a top load carrier configured to couple to the second body proximate to a top edge of the back wall such that the top load carrier extends between the opposing second sidewalls when coupled to the second body and secures the second body to the vehicle.

7. The bifurcated storage compartment of claim 6, wherein the top load carrier comprises an elongate body with a first snap hook proximate to a first end of the elongate body and a second snap hook proximate to a second end of the elongate body, wherein the first snap hook is configured to be coupled to the back wall proximate to the top edge of the back wall and one sidewall of the opposing second sidewalls, and the second snap hook is configured to be coupled to the back wall proximate to the top edge of the back wall and other sidewall of the opposing second sidewalls.

8. The bifurcated storage compartment of claim 7, wherein the second body of the second container segment includes a top flange extending from a top edge of the back wall, the top flange defining a plurality of retention cavities or holes, and wherein the top load carrier includes a plurality of protrusions positioned between the first and second ends of the elongate body such that, when the top load carrier is coupled to the back wall of the second body, the plurality of protrusions of the top load carrier are received within the retention cavities or holes defined by the top flange to secure the top load carrier to the back wall.

9. The bifurcated storage compartment of claim 2, further comprising:
a bottom load carrier configured to enclose the at least one first flange and the at least one second flange when the at least one first flange and the at least one second flange are coupled together such that the at least one first flange and the at least one second flange are secured together.

10. The bifurcated storage compartment of claim 2, further comprising:
at least one sealing strip configured to be positioned between the at least one first flange and the at least one second flange such that, when the at least one first flange and the at least one second flange are coupled together and secured, a seal is created therebetween.

11. The bifurcated storage compartment of claim 2, wherein at least one of a plurality of screws or a plurality of clips of the at least one first flange are configured to retain the at least one second flange when the at least one first flange and the at least one second flange are coupled together.

12. The bifurcated storage compartment of claim 2, wherein the at least one second flange includes a second rib protruding from the at least one second flange such that a channel is defined between the second rib of the at least one second flange and the exterior of the second body, the channel configured to house a sealing element.

13. The bifurcated storage compartment of claim 12, wherein the at least one first flange includes a first rib protruding from the at least one first flange, the first rib configured to compress the sealing element housed within the channel of the second body to create a seal therebetween when the at least one first flange and the at least one second flange are coupled together and secured.

14. The bifurcated storage compartment of claim 13, wherein the at least one first flange includes a plurality of steering ribs protruding from at least one of the at least one first flange or the first rib and spaced along the at least one first flange with some distance in between, the plurality of steering ribs configured to be received within the channel defined by the second rib in order steer the at least one first flange and the at least one second flange together and ensure an even interface therebetween when the at least one first flange and the at least one second flange are coupled together and secured.

15. The bifurcated storage compartment of claim 2, wherein the at least one first flange includes at least one steering pin, and the at least one second flange defines at least one guide hole or guide cavity configured to receive the at least one steering pin in order to ensure a proper alignment when the at least one first flange and the at least one second flange are coupled together.

16. The bifurcated storage compartment of claim 1, wherein the first body is a monolithic structure comprising a first material, and the second body is a monolithic structure comprising a second material different than the first material.

17. A split-configuration storage compartment for a vehicle, the split-configuration storage compartment comprising:
a first container segment including a first body defining a first recessed interior and configured to be secured to the vehicle;
a second container segment including a second body defining a second recessed interior and configured to be secured to the vehicle; and
a living hinge positioned between and coupling the first body to the second body such that the first container segment and the second container segment each extend from the living hinge to form the split-configuration storage compartment.

18. The split-configuration storage compartment of claim 17, wherein the first container segment further comprises a plurality of first flanges, each first flange extending from an exterior of the first body such that the plurality of first flanges at least partially defines a perimeter of the first recessed interior, and the second container segment further comprises a plurality of second flanges, each second flange extending from an exterior of the second body such that the plurality of second flanges at least partially defines a perimeter of the second recessed interior, and
wherein the plurality of first flanges and the plurality of second flanges define complementary profiles such that the plurality of first flanges and the plurality of second flanges may be coupled together to form a cavity from the first recessed interior and the second recessed interior, the cavity configured to store items or cargo.

19. The split-configuration storage compartment of claim 18, further comprising:
a bottom load carrier configured to enclose the plurality of first flanges and the plurality of second flanges when the plurality of first flanges and the plurality of second flanges are coupled together such that the plurality of first flanges and the plurality of second flanges are secured together.

20. The split-configuration storage compartment of claim 19, further comprising:
a plurality of sealing strips, each sealing strip configured to be positioned between one first flange of the plurality of first flanges and one second flange of the plurality of second flanges such that, when the plurality of first flanges and the plurality of second flanges are coupled together and secured, a seal is created between the first container segment and the second container segment in combination with the living hinge.
